(19) United States
(12) Patent Application Publication
(10) Pub. No.: US 2017/0015009 A1
(43) Pub. Date: Jan. 19, 2017

(54) CUTTING STRUCTURE FOR UTILITY KNIFE

(71) Applicant: MIN-CHENG TSENG, Nantou City (TW)

(72) Inventor: MIN-CHENG TSENG, Nantou City (TW)

(21) Appl. No.: 14/801,751

(22) Filed: Jul. 16, 2015

(51) Int. Cl. B26B 5/00; B26B 29/02

(52) U.S. Cl. CPC B26B 5/001; B26B 29/025

(57) ABSTRACT

A cutting structure for a utility knife contains: a casing, a holder, a push knob, a positioning member, and two switch buttons. The casing includes two connecting parts, each having a rail, an opening, and a cutout. The holder includes two accommodation grooves, each being arranged on each of two side surfaces of the holder. The push knob is adapted to drive the holder. The positioning member includes a rotary stem and a protrusion. The two switch buttons are mounted in two cutouts of the two connecting parts, and each switch button has a pressing tab extending out of each cutout from an outer wall thereof and its inner wall abuts against each of two side surfaces of the positioning member. Each switch button also has a fixing rib arranged on an inner surface thereof to retain with one of two blades which does not engage with the protrusion.

### FIELD OF THE INVENTION

The present invention relates to a cutting structure for a utility knife which allows accommodating and replacing two blades of different specifications based on using requirements.

### BACKGROUND OF THE INVENTION

A conventional utility knife contains a casing, a holder, a magazine, and a resilient element.

The casing includes a front room, an elongated orifice communicating with the front room and an exterior environment, an orifice communicating with the front room, a rear room communicating with the front room, and an opening communicating with the rear room and the exterior environment. The holder includes a body formed on the front room of the casing and includes an arm extending outwardly from the body and extending out of the casing from the elongated orifice. The magazine is accommodated in the rear room of the casing from the opening and includes an accommodation chamber, a first groove communicating with the accommodation chamber and the exterior environment, a second groove communicating with the accommodation chamber and the rear room of the casing, an aperture communicating with the accommodation chamber and the front room of the casing, and a push block slidably fixed in the accommodation chamber, wherein the push block has a main part and a control element extending outwardly from the main part and accommodated in the first groove of the magazine. The resilient element is mounted in the rear room of the casing, and a first end of the resilient element is fixed in the casing, a second end of the resilient element extends into the accommodation chamber from the second groove of the magazine.

Furthermore, a blade is secured in the utility knife and is pushed out of the casing by the push block to cut an object or to be replaced. However, the blade is in a single specification, so a user cannot cut the object by using blades of different specifications based on using requirements.

The present invention has arisen to mitigate and/or obviate the afore-described disadvantages.

### SUMMARY OF THE INVENTION

The primary objective of the present invention is to provide a cutting structure for a utility knife which allows accommodating and replacing two blades of different specifications based on using requirements.

To obtain the above objective, a cutting structure for a utility knife provided by the present invention contains: a casing, a holder, a push knob, a positioning member, and two switch buttons.

The casing includes two connecting parts symmetrically connected together, and each connecting part has a rail on which the push knob slides, each connecting part also has an opening defined on a front end thereof to extend a blade out of the opening and has a cutout formed on an outer surface thereof.

The holder includes two accommodation grooves, and each accommodation groove is arranged on each of two side surfaces of the holder to accommodate each of two blades.

The push knob is adapted to drive the holder.

The positioning member includes a rotary stem disposed on a first end thereof and rotatably connected with a top surface of the holder, and the positioning member also includes a protrusion extending downwardly from a second end thereof and extending into each accommodation groove to selectively engage with one of the two blades as the positioning member moves, wherein as the two blades are retracted backward, two side surfaces of the positioning member correspond to two cutouts of the two connecting parts.

The two switch buttons are mounted in the two cutouts of the two connecting parts, and each switch button has a pressing tab extending out of each cutout from an outer wall thereof and its inner wall abuts against each of the two side surfaces of the positioning member, wherein each switch button also has a fixing rib arranged on an inner surface thereof to retain with one of the two blades which does not engage with the protrusion.

The push knob includes a fitting mount disposed on a bottom end thereof to vertically fit with the holder, and the holder also includes a spring for abutting against the bottom end of the push knob, such that the push knob moves vertically relative to the holder; the casing further includes a first shoulder and a second shoulder which are arranged on an inner surface of each connecting part under the rail of each connecting part, wherein a distance between the first shoulder and the cutout of each connecting part is less than a distance between the second shoulder and the cutout of each connecting part; the push knob further has two recesses, and each recess is formed on each of two side surfaces of the push knob to retain with the first shoulder or the second shoulder of each connecting part.

The holder further includes a resilient piece for abutting against the positioning member; the positioning member further includes a first extension extending outwardly from an upper end thereof, and the push knob further includes a second extension extending outwardly from the bottom end thereof and corresponding to the first extension of the positioning member, wherein a length of the first extension is more than that of the second shoulder, such that when the push knob retains with the second shoulder, the first extension does not interfere with the second extension; and when the push knob retains with the first shoulder, the first extension crosswisely contacts with the second extension; the positioning member further includes a horizontal shaft formed on the upper end thereof, and each connecting part of the casing has a slidable block mounted on the inner surface thereof proximate to the opening of each connecting part, the slidable block has a tilted guiding face defined on an inner surface thereof to push the horizontal shaft to move upwardly.

The holder further includes a through hole communicating with the two accommodation grooves and includes a stop plate rotatably coupled with the through hole, wherein two side surfaces of the stop plate are pressed by the two switch buttons to extend toward one of the two accommodation grooves, the holder includes a receiving orifice formed on the top surface thereof and communicating with the through hole to receive the spring, and the holder also includes a steel ball fixed in the receiving orifice and pushed by the spring, the stop plate has a conical seat arranged on an upper side thereof to abut against the steel ball.

The cutting structure further contains a handle rotatably connecting with the casing. The handle includes a storage slot formed thereon to accommodate the casing and includes two slidable retainers secured on two side surfaces thereof, and each connecting part of the casing includes a first notch and a second notch which are defined on an outer surface of each connecting part to selectively retain with each of the two slidable retainers; wherein when each slidable retainer retains with the first notch, the handle expands outwardly relative to the casing, and when each slidable retainer retains with the second notch, the handle retracts inwardly relative to the casing.

### BRIEF DESCRIPTION OF THE DRAWINGS

FIG. 1 is a perspective view showing the exploded components of a part of a cutting structure for a utility knife according to a preferred embodiment of the present invention.

FIG. 2 is another perspective view showing the exploded components of a part of the cutting structure for the utility knife according to the preferred embodiment of the present invention.

FIG. 3 is a perspective view showing the assembly of the cutting structure for the utility knife according to the preferred embodiment of the present invention.

FIG. 4 is a side plan view showing the assembly of a part of the cutting structure for the utility knife according to the preferred embodiment of the present invention.

FIG. 5 is another side plan view showing the assembly of a part of the cutting structure for the utility knife according to the preferred embodiment of the present invention.

FIG. 6 is a cross sectional view taken along the lines of B-B of FIG. 5.

FIG. 7 is another cross sectional view taken along the lines of B-B of FIG. 5.

FIG. 8 is a cross sectional view taken along the lines of A-A of FIG. 4.

FIG. 9 is another cross sectional view taken along the lines of A-A of FIG. 4.

FIG. 10 is also another cross sectional view taken along the lines of A-A of FIG. 4.

FIG. 11 is an amplified cross sectional view of a portion C of FIG. 6.

FIG. 12 is another amplified cross sectional view of a portion C of FIG. 6.

FIG. 13 is a cross sectional view showing the operation of a part of the cutting structure for the utility knife according to the preferred embodiment of the present invention.

FIG. 14 is another cross sectional view showing the operation of a part of the cutting structure for the utility knife according to the preferred embodiment of the present invention.

### DETAILED DESCRIPTION OF THE PREFERRED EMBODIMENTS

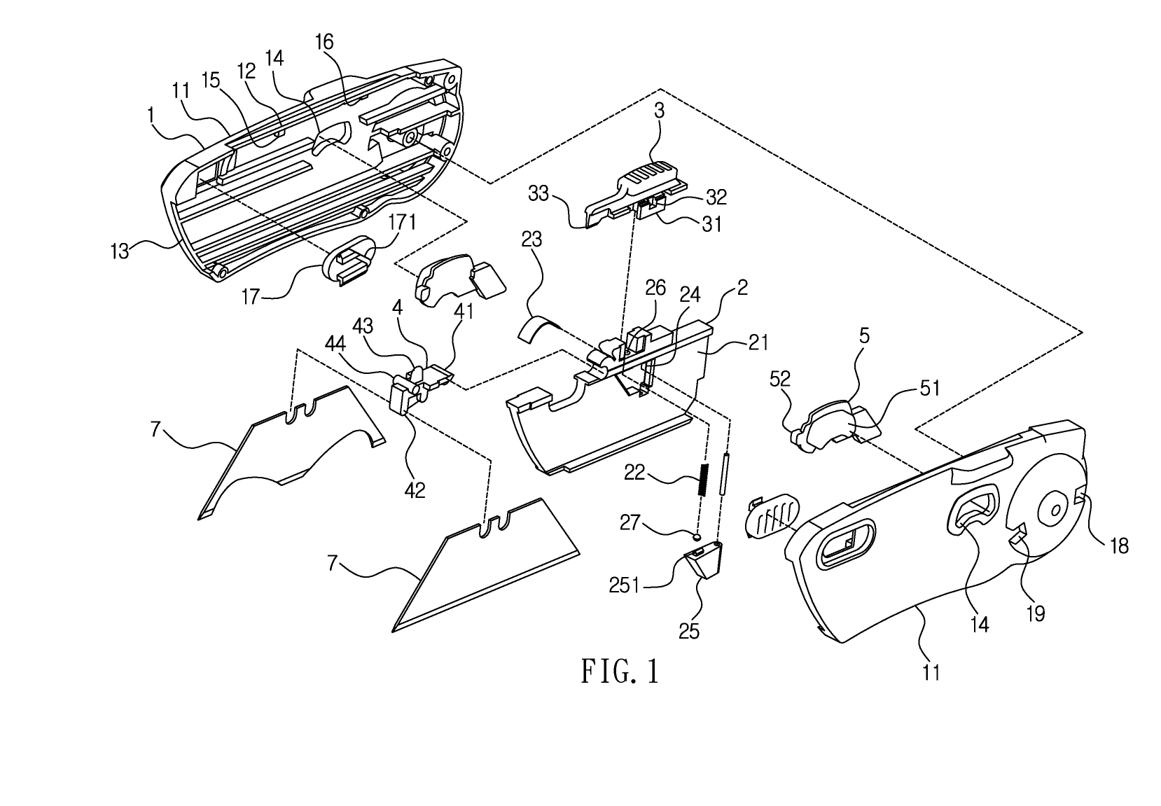

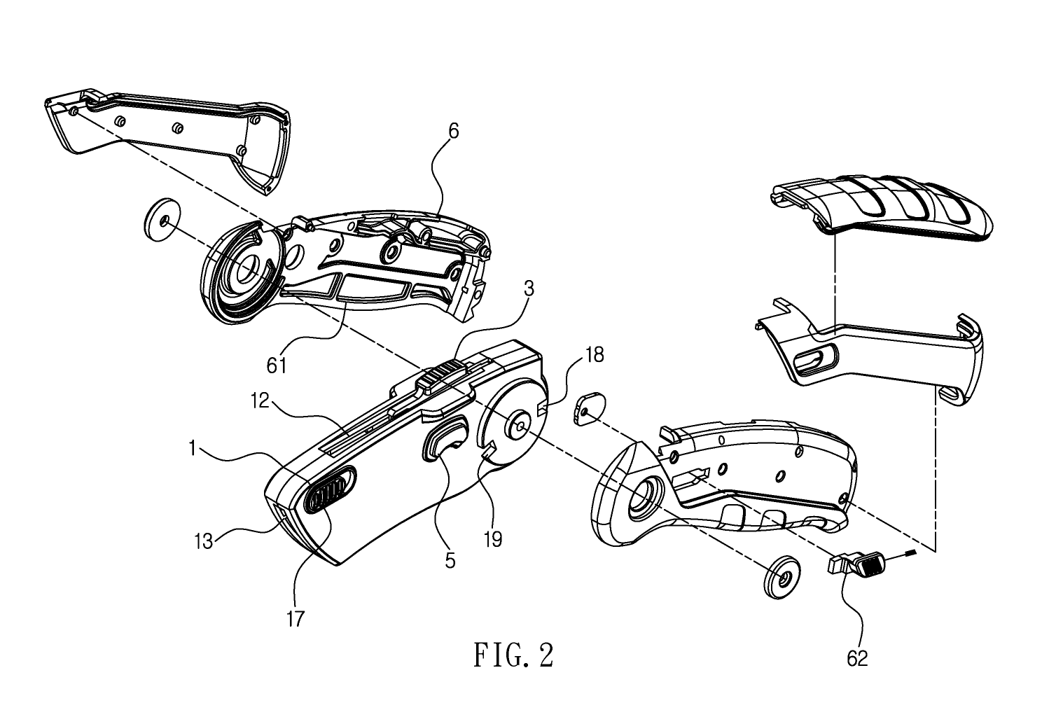

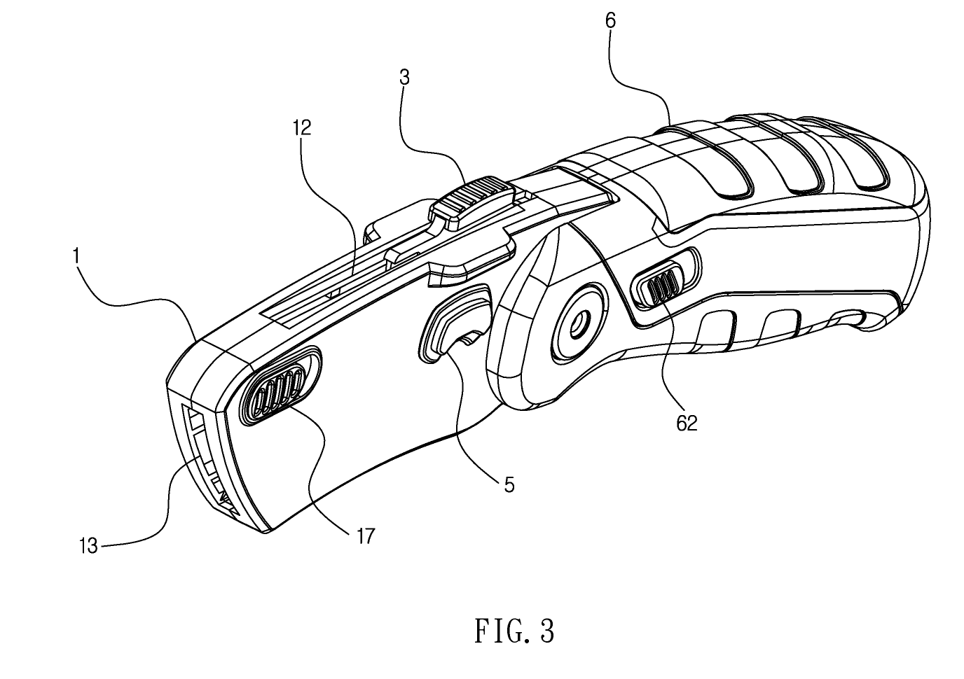

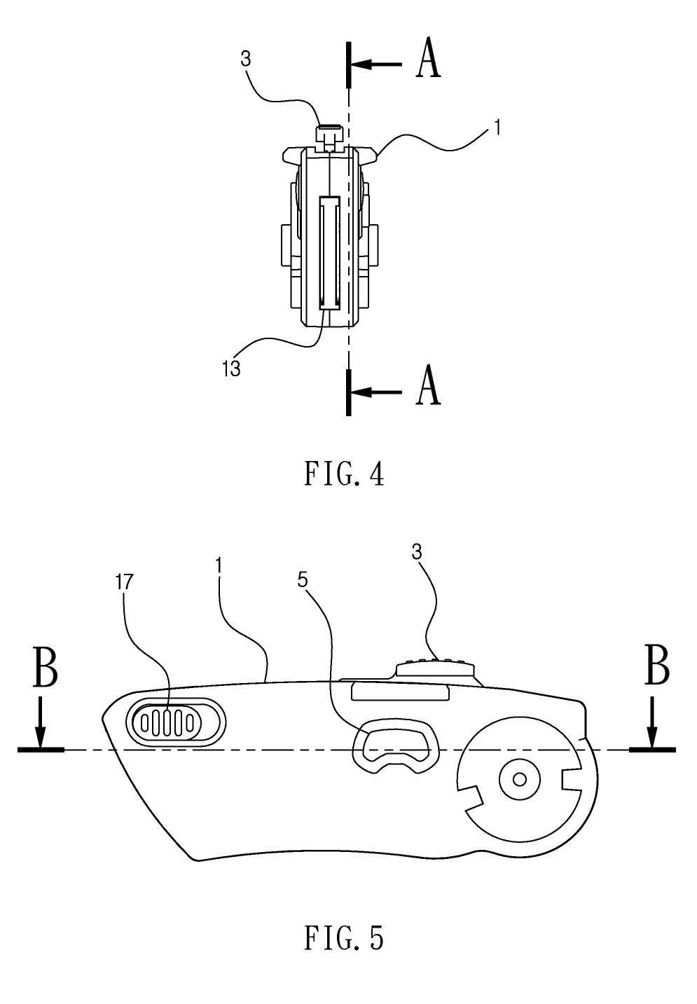

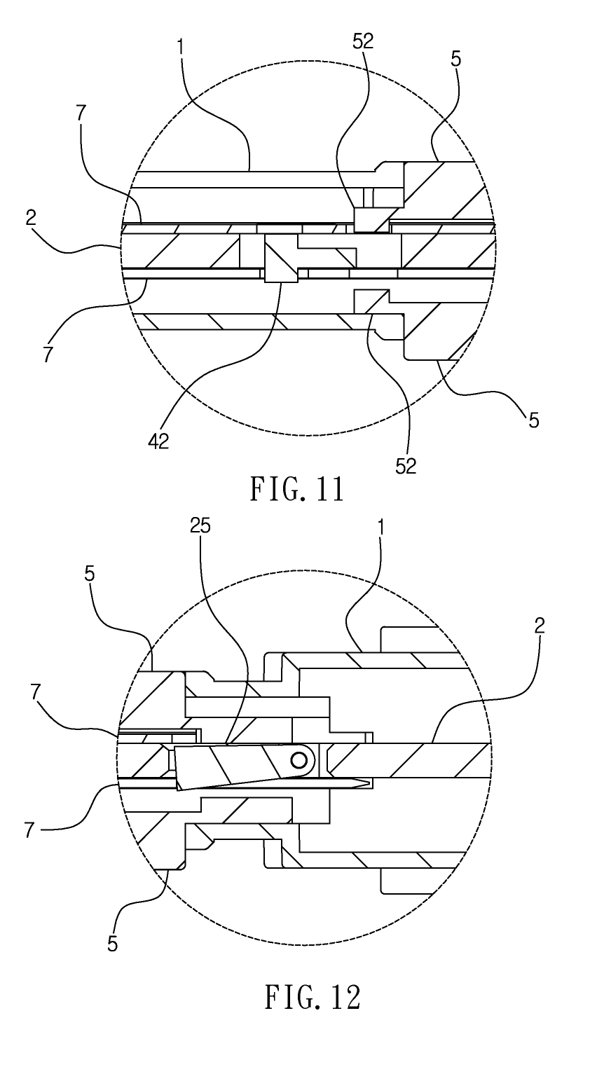

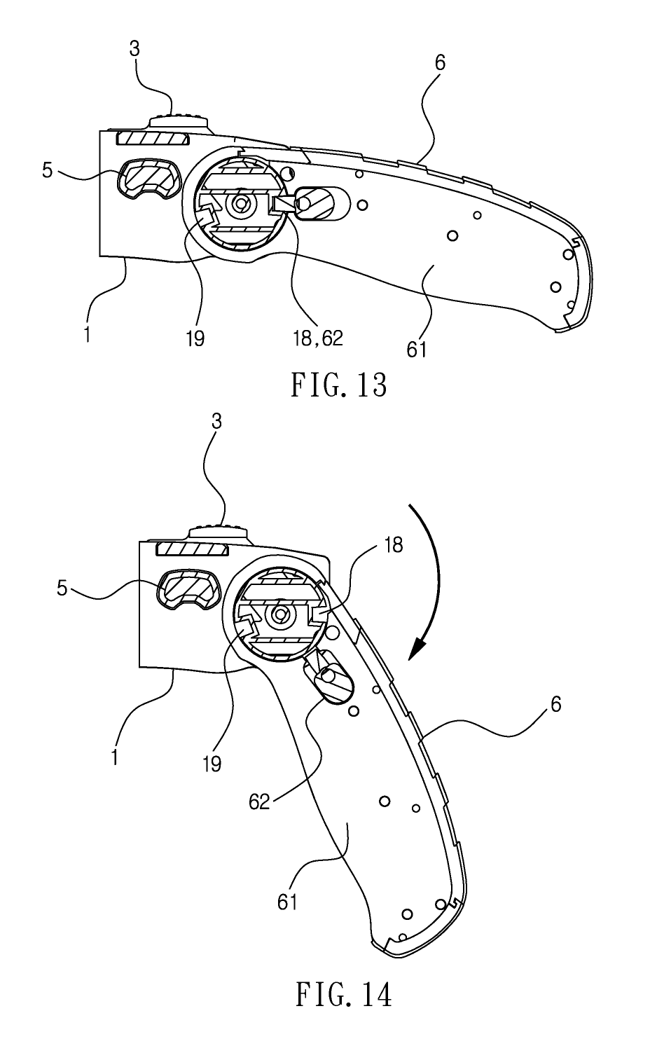

With reference to FIGS. 1 to 14, a cutting structure for a utility knife according to a preferred embodiment of the present invention allows accommodating and replacing two blades of different specifications based on using requirements and comprises: a casing 1, a holder 2, a push knob 3, a positioning member 4, and two switch buttons 5.

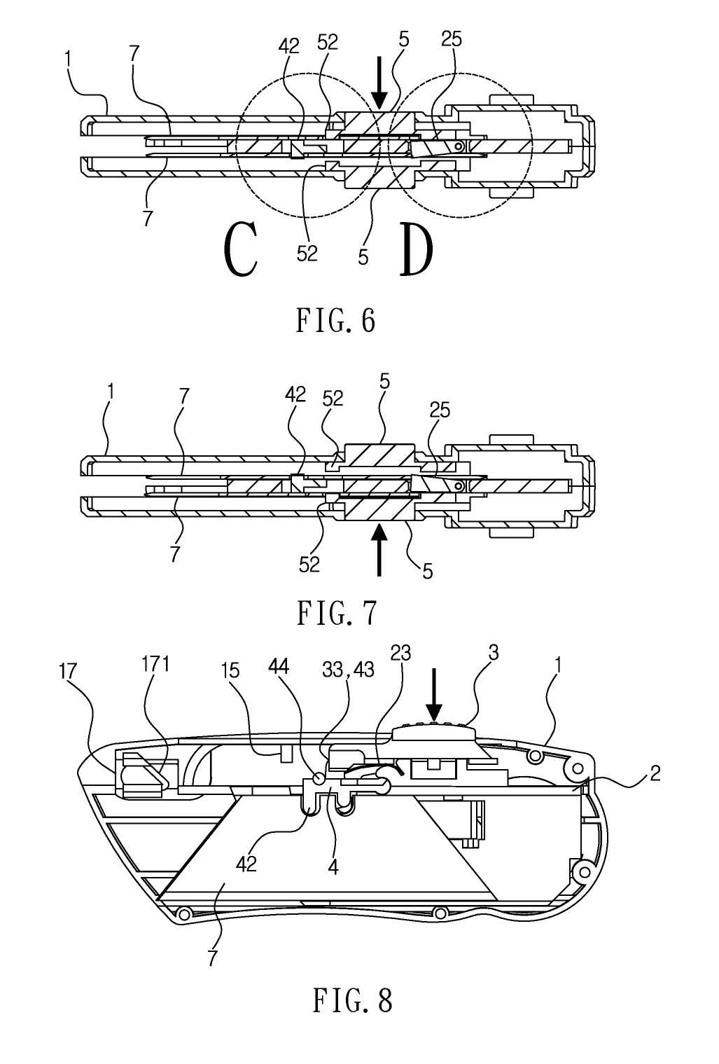

The casing 1 includes two connecting parts 11 symmetrically connected together, and each connecting part 11 has a rail 12 on which the push knob 3 slides, each connecting part 11 also has an opening 13 defined on a front end thereof to extend a blade 7 out of the opening 13 and has a cutout 14 formed on an outer surface thereof. The holder 2 includes two accommodation grooves 21, and each accommodation groove 21 is arranged on each of two side surfaces of the holder 2 to accommodate each of two blades 7. The push knob 3 is adapted to drive the holder 2 as being pressed by a user. The positioning member 4 includes a rotary stem 41 disposed on a first end thereof and rotatably connected with a top surface of the holder 2, and the positioning member 4 also includes a protrusion 42 extending downwardly from a second end thereof and extending into each accommodation groove 21 to selectively engage with one of the two blades 7 as the positioning member 4 moves, wherein as the two blades 7 are retracted backward, two side surfaces of the positioning member 4 correspond to two cutouts 14 of the two connecting parts 11. The two switch buttons 5 are mounted in the two cutouts 14 of the two connecting parts 11, and each switch button 5 has a pressing tab 51 extending out of each cutout 14 from an outer wall thereof and its inner wall abuts against each of the two side surfaces of the positioning member 4, such that when the two switch buttons 5 are pressed, the positioning member 4 is driven by the two switch buttons 5 to move leftward or rightward (as shown in FIGS. 6 and 7). Each switch button 5 also has a fixing rib 52 arranged on an inner surface thereof to retain with one of the two blades 7 which does not engage with the protrusion 42.

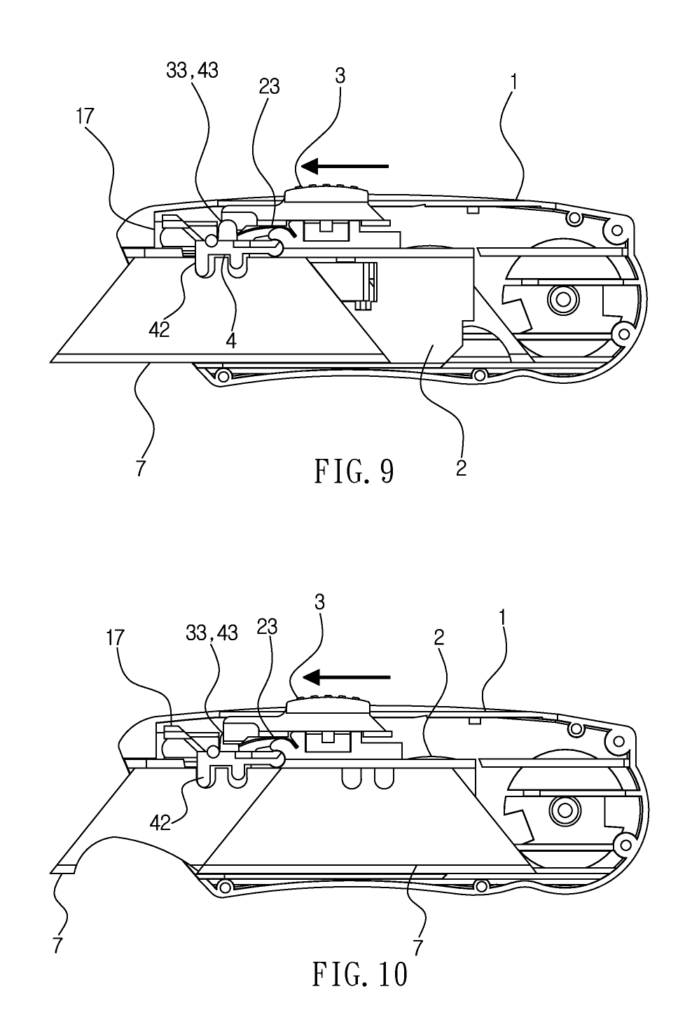

Referring to FIGS. 8 and 9, after the push knob 3 is pushed forward by the user, one of the two blades 7 is driven by the push knob 3 to move out of one of two openings 13 of the two connecting parts 11, thus cutting an object by using the one of the two blades 7. As desiring to replace the other of the two blades 7, the push knob 3 is pushed backward so that the one of the two blades 7 moves back into the casing 1, in the meantime, the two side surfaces of the positioning member 4 correspond to two inner walls of the two switch buttons 5, and one of the two switch buttons 5, which outwardly extends a distance more than the other of the two switch buttons 5, is pressed, hence the positioning member 4 is pushed by the one of the two switch buttons 5 to move leftward, and the protrusion 42 of the positioning member 4 engages with the other of the two blades 7, thus pushing the other of the two blades 7 out of the other of the two openings 13 to cut the object (as illustrated in FIG. 10). Preferably, the one of the two blades 7 is retained by a fixing rib 52 of the one of the two switch button 5 to fix in the casing 1 securely, when the other of the two blades 7 extends out of the other of the two openings 13.

In addition, the push knob 3 includes a fitting mount 31 disposed on a bottom end thereof to vertically fit with the holder 2, and the holder 2 also includes a spring 22 for abutting against the bottom end of the push knob 3, such that the push knob 3 moves vertically relative to the holder 2. The casing 1 further includes a first shoulder 15 and a second shoulder 16 which are arranged on an inner surface of each connecting part 11 under the rail 12 of each connecting part 11, wherein a distance between the first shoulder 15 and the cutout 14 of each connecting part 11 is less than a distance between the second shoulder 16 and the cutout 14 of each connecting part 11. The push knob 3 further has two recesses 32, and each recess 32 is formed on each of two side surfaces of the push knob 3 to retain with the first shoulder 15 or the second shoulder 16 of each connecting part 11, such that after the push knob 3 is pressed to force the spring 22, it moves so that when each recess 32 of the push knob 3 retains with the first shoulder 15, the holder 2 is in a blade expending state; and when each recess 32 retains with the second shoulder 16, the holder 2 is in a blade retracting state.

Furthermore, the holder 2 further includes a resilient piece 23 for abutting against the positioning member 4, such that the protrusion 42 flexibly retains the two blades 7. The positioning member 4 further includes a first extension 43 extending outwardly from an upper end thereof, and the push knob 3 further includes a second extension 33 extending outwardly from the bottom end thereof and corresponding to the first extension 43 of the positioning member 4, wherein a length of the first extension 15 is more than that of the second shoulder 16, such that when the push knob 3 retains with the second shoulder 16, the first extension 43 does not interfere with the second extension 33; and when the push knob 3 retains with the first shoulder 15, the first extension 43 crosswisely contacts with the second extension 33(as shown in FIGS. 9 and 10). The positioning member 4 further includes a horizontal shaft 44 formed on the upper end thereof, and each connecting part 11 of the casing 1 has a slidable block 17 mounted on the inner surface thereof proximate to the opening 13 of each connecting part 11, and the slidable block 17 has a tilted guiding face 171 defined on an inner surface thereof to push the horizontal shaft 44 to move upwardly, such that when the push knob 3 retains with the first extension 145, the positioning member 4 is located proximate to the opening 13 of each connecting part 11, and when the slidable block 17 is pushed, its tilted guiding face 171 pushes the horizontal shaft 44 of the positioning member 4 to move upwardly, thus releasing one of the two blades 7. Thereafter, the one of the two blades 7 is removed from the opening 13. Furthermore, the first extension 43 and the second extension 33 crosswisely contact with each other after pressing the push knob 3, such that the positioning member 4 is driven by the push knob 3 to slide stably.

The holder 2 further includes a through hole 24 communicating with the two accommodation grooves 21 and includes a stop plate 25 rotatably coupled with the through hole 24, wherein two side surfaces of the stop plate 25 are pressed by the two switch buttons 5 to extend toward one of the two accommodation grooves 21 (as illustrated in FIG. 12). The holder 2 includes a receiving orifice 26 formed on the top surface thereof and communicating with the through hole 24 to receive the spring 22, and the holder 2 also includes a steel ball 27 fixed in the receiving orifice 26 and pushed by the spring 22, the stop plate 25 has a conical seat 251 arranged on an upper side thereof to abut against the steel ball 27, such that the spring 22 and the steel ball 27 position the stop plate 25 on one side of the one of the two blades 7, hence the one of the two blades 7 cuts the object securely.

The cutting structure for the utility knife further comprises a handle 6 rotatably connecting with the casing 1, wherein the handle 6 includes a storage slot 61 formed thereon to accommodate the casing 1 and includes two slidable retainers 62 secured on two side surfaces thereof, and each connecting part 11 of the casing 1 includes a first notch 18 and a second notch 19 which are defined on an outer surface of each connecting part 11 to selectively retain with each of the two slidable retainers 62, wherein when each slidable retainer 62 retains with the first notch 18, the handle 6 expands outwardly relative to the casing 1, and when each slidable retainer 62 retains with the second notch 19, the handle 6 retracts inwardly relative to the casing 1.

Thereby, the cutting structure of the present invention contains the two accommodation grooves 21 to accommodate the two blades 7 of different specifications, and the two switch buttons 5 are configured to switch the two blades 7 according to the using requirements.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A cutting structure for a utility knife comprising: a casing, a holder, a push knob, a positioning member, and two switch buttons, wherein
the casing includes two connecting parts symmetrically connected together, and each connecting part has a rail on which the push knob slides, each connecting part also has an opening defined on a front end thereof to extend a blade out of the opening and has a cutout formed on an outer surface thereof;
the holder includes two accommodation grooves, and each accommodation groove is arranged on each of two side surfaces of the holder to accommodate each of two blades;
the push knob is adapted to drive the holder;
the positioning member includes a rotary stem disposed on a first end thereof and rotatably connected with a top surface of the holder, and the positioning member also includes a protrusion extending downwardly from a second end thereof and extending into each accommodation groove to selectively engage with one of the two blades as the positioning member moves, wherein as the two blades are retracted backward, two side surfaces of the positioning member correspond to two cutouts of the two connecting parts;
the two switch buttons are mounted in the two cutouts of the two connecting parts, and each switch button has a pressing tab extending out of each cutout from an outer wall thereof and its inner wall abuts against each of the two side surfaces of the positioning member, wherein each switch button also has a fixing rib arranged on an inner surface thereof to retain with one of the two blades which does not engage with the protrusion.

2. The cutting structure for the utility knife as claimed in claim 1, wherein the push knob includes a fitting mount disposed on a bottom end thereof to vertically fit with the holder, and the holder also includes a spring for abutting against the bottom end of the push knob, such that the push knob moves vertically relative to the holder; the casing further includes a first shoulder and a second shoulder which are arranged on an inner surface of each connecting part under the rail of each connecting part, wherein a distance between the first shoulder and the cutout of each connecting part is less than a distance between the second shoulder and the cutout of each connecting part; the push knob further has two recesses, and each recess is formed on each of two side surfaces of the push knob to retain with the first shoulder or the second shoulder of each connecting part.

3. The cutting structure for the utility knife as claimed in claim 2, wherein the holder further includes a resilient piece for abutting against the positioning member; the positioning member further includes a first extension extending outwardly from an upper end thereof, and the push knob further includes a second extension extending outwardly from the bottom end thereof and corresponding to the first extension of the positioning member, wherein a length of the first extension is more than that of the second shoulder, such that when the push knob retains with the second shoulder, the first extension does not interfere with the second extension; and when the push knob retains with the first shoulder, the first extension crosswisely contacts with the second extension; the positioning member further includes a horizontal shaft formed on the upper end thereof, and each connecting part of the casing has a slidable block mounted on the inner surface thereof proximate to the opening of each connecting part, the slidable block has a tilted guiding face defined on an inner surface thereof to push the horizontal shaft to move upwardly.

4. The cutting structure for the utility knife as claimed in claim 3, wherein the holder further includes a through hole communicating with the two accommodation grooves and includes a stop plate rotatably coupled with the through hole, wherein two side surfaces of the stop plate are pressed by the two switch buttons to extend toward one of the two accommodation grooves, the holder includes a receiving orifice formed on the top surface thereof and communicating with the through hole to receive the spring, and the holder also includes a steel ball fixed in the receiving orifice and pushed by the spring, the stop plate has a conical seat arranged on an upper side thereof to abut against the steel ball.

5. The cutting structure for the utility knife as claimed in claim 1 further comprises a handle rotatably connecting with the casing, wherein the handle includes a storage slot formed thereon to accommodate the casing and includes two slidable retainers secured on two side surfaces thereof, and each connecting part of the casing includes a first notch and a second notch which are defined on an outer surface of each connecting part to selectively retain with each of the two slidable retainers; wherein when each slidable retainer retains with the first notch, the handle expands outwardly relative to the casing, and when each slidable retainer retains with the second notch, the handle retracts inwardly relative to the casing.
